(19) United States
(12) Patent Application Publication
(10) Pub. No.: US 2015/0103866 A1
(43) Pub. Date: Apr. 16, 2015

(54) DIGITAL TEMPERATURE ESTIMATORS (DTEs) DISPOSED IN INTEGRATED CIRCUITS (ICs) FOR ESTIMATING TEMPERATURE WITHIN THE ICs, AND RELATED SYSTEMS AND METHODS

(71) Applicant: QUALCOMM Incorporated, San Diego, CA (US)

(72) Inventors: Kambiz Samadi, San Diego, CA (US); Yang Du, Carlsbad, CA (US); Mehdi Saeidi, San Diego, CA (US)

(73) Assignee: QUALCOMM Incorporated, San Diego, CA (US)

(21) Appl. No.: 14/091,390

(22) Filed: Nov. 27, 2013

Related U.S. Application Data
(60) Provisional application No. 61/889,568, filed on Oct. 11, 2013.

(51) Int. Cl. G01K 7/42; G01K 1/02

(52) U.S. Cl. CPC G01K 7/427; G01K 1/022
USPC 374/170

(57) ABSTRACT

Embodiments disclosed in the detailed description include digital temperature estimators (DTEs) disposed in integrated circuits (ICs) for estimating temperature within the ICs. Related systems and methods are also disclosed. In one embodiment, the DTEs can be used to estimate temperatures in an IC by implementing a temperature estimation model (TEM). The TEM can provide an estimated temperature of an IC block disposed in the IC based on activity event(s) associated with the IC block, as opposed to providing temperature sensors in the IC to measure temperature of the IC block directly. The DTEs can be operated in real time so that power and/or thermal regulation systems of the IC can obtain accurate and reliable temperature estimation from the DTEs. In this manner, thermal dissipation in the IC may be regulated more effectively.

### PRIORITY CLAIM

The present application claims priority to U.S. Provisional Patent Application Ser. No. 61/889,568 filed on Oct. 11, 2013 and entitled “DIGITAL TEMPERATURE ESTIMATORS (DTEs) DISPOSED IN INTEGRATED CIRCUITS (ICs) FOR ESTIMATING TEMPERATURE WITHIN THE ICs, AND RELATED SYSTEMS AND METHODS,” which is incorporated herein by reference in its entirety.

### BACKGROUND

I. Field of the Disclosure

The technology of the disclosure relates generally to systems and methods of determining temperature of an integrated circuit (IC).

II. Background

Thermal emissions are a problem of increasing concern in integrated circuit (IC) design. High temperatures in an IC may cause carrier mobility degradation and thus slow down operation of the IC, increase resistivity, and/or cause circuit failures. The problem has become especially critical as voltage scaling has slowed down and the number of active components per unit area has increased. Thus, control systems need accurate temperature determinations in order to control thermal dissipation in an IC.

Traditional temperature detection techniques rely on temperature sensors, which may, for example, use bipolar junction transistors (BJTs). In these temperature sensors, a power level of a temperature sensor is often detected to measure the IC's temperature. Unfortunately, deficiencies in these types of temperature sensors have become increasingly problematic. For example, the relationship between the temperature and the power level of the temperature sensor becomes increasingly non-linear as power densities increase in ICs. Furthermore, precision has become increasingly important in thermal management. However, the precision of traditional temperature sensors is limited by accuracy in placement within the IC, along with inadequate response times and gain resolutions of BJTs. Expensive cooling solutions are often used to correct these deficiencies, thereby increasing manufacturing costs. More accurate temperature determination techniques are therefore needed.

### SUMMARY OF THE DISCLOSURE

Embodiments disclosed in the detailed description include digital temperature estimators (DTEs) disposed in integrated circuits (ICs) for estimating temperature within the ICs. Related systems and methods are also disclosed. In one embodiment, the DTEs can be used to estimate temperatures in an integrated circuit (IC) by implementing a temperature estimation model (TEM). The TEM can provide an estimated temperature of an IC block disposed in the IC based on activity event(s) associated with the IC block, as opposed to providing temperature sensors in the IC to measure temperature of the IC block directly. Implementation of the TEM allows for temperatures in the IC and IC blocks disposed therein to be estimated even if the temperatures of the IC are highly non-linear with respect to power consumption in the IC. The DTEs can be operated in real time so that power and/or thermal regulation systems of the IC can obtain accurate and reliable temperature estimation from the DTE. In this manner, the thermal dissipation in the IC may be regulated more effectively. For example, power consumption in the IC may be controlled more precisely to maintain the IC within desired temperature limits. As another example, voltage scaling may be performed in the IC based on the estimated temperature may be provided more accurately.

In this regard, in one embodiment, a DTE is disposed in an IC having a plurality of IC blocks. The DTE includes an IC block activity file, a TEM, and a temperature estimation calculator. The IC block activity file is configured to store IC block activity events associated with the plurality of IC blocks disposed in the IC. The TEM is configured to correlate the IC block activity events from the IC block activity file to temperature. To estimate a temperature of one or more IC blocks, the temperature estimation calculator is configured to receive one or more IC block identifiers of the one or more IC blocks. The temperature estimation calculator then implements the TEM to calculate one or more temperature estimations of the one or more IC blocks identified by the one or more IC block identifiers. The temperature estimation calculator causes the one or more temperature estimations of the one or more IC blocks to be stored in memory.

In another embodiment, a DTE is disposed in an IC. The DTE includes means for storing IC block activity events associated with a plurality of IC blocks disposed in the IC. Additionally, the DTE includes means for receiving an IC block identifier to estimate temperature of an IC block of the plurality of IC blocks identified by the IC block identifier. The DTE further includes means for calculating a temperature estimation of the IC block identified by the IC block identifier. The DTE includes means for storing the temperature estimation of the IC block identified by the IC block identifier.

In another embodiment, a temperature estimation method is disclosed. To implement the temperature estimation method, a TEM configured to correlate IC block activity events to temperature is stored. During operation of an IC, the IC block activity events associated with a plurality of IC blocks disposed in the IC are obtained. An IC block identifier is also obtained to estimate temperature of an IC block of the plurality of IC blocks identified by the IC block identifier. The TEM is implemented to calculate a temperature estimation of the IC block identified by the IC block identifier. The temperature estimation of the IC block identified by the IC block identifier is then stored in memory.

In another embodiment, an IC is disclosed that includes a plurality of IC blocks and a DTE. The DTE is configured to obtain IC block activity events associated with the plurality of IC blocks. The DTE also has a TEM and is configured to implement the TEM to calculate one or more temperature estimations that estimate one or more temperatures of one or more of the plurality of IC blocks as a function of the IC block activity events.

In another embodiment, a non-transitory computer-readable medium has computer-executable instructions stored thereon. The computer-executable instructions cause a DTE to store a TEM configured to correlate IC block activity events to temperature. The computer-executable instructions further cause the DTE to obtain the IC block activity events associated with a plurality of IC blocks disposed in an IC. The computer-executable instructions also cause the DTE to receive an IC block identifier to estimate temperature of an IC block of the plurality of IC blocks identified by the IC block identifier. Additionally, the computer-executable instructions cause the DTE to implement the TEM to calculate a temperature estimation of the IC block identified by the IC block identifier. Finally, the computer-executable instructions cause the DTE to store the temperature estimation of the IC block identified by the IC block identifier in memory.

### BRIEF DESCRIPTION OF THE FIGURES

FIG. 1 illustrates an exemplary integrated circuit (IC) that includes a plurality of IC blocks and a digital temperature estimator (DTE) disposed in the IC, wherein the DTE configured to estimate temperature of one or more IC blocks disposed in the IC;

FIG. 2 illustrates an exemplary temperature estimation method that may be performed by the DTE in FIG. 1;

FIG. 3 illustrates an exemplary digital power and temperature module (DPTM), which may be provided as the DTE in FIG. 1;

FIG. 4 illustrates an exemplary IC formed in an electronic package, which may be the IC shown in FIG. 1;

FIG. 5 illustrates exemplary mathematical expressions that may be employed by the temperature estimation model (TEM) of the DPTM of the IC in FIGS. 3 and 4 to estimate temperature of one or more IC blocks within the IC;

FIG. 6 illustrates an exemplary cross-section of the IC package in FIG. 4;

FIG. 7 is a graph that illustrates an exemplary relationship between a temperature estimation of an IC block in an IC and a displacement between the IC block and another IC block in the IC;

FIG. 8 is a graph that illustrates an exemplary relationship between a temperature estimation of an IC block in an IC and a power estimation of the IC block in the IC;

FIG. 9 illustrates an exemplary relationship between a temperature estimation of an IC block in an IC and a thermal conductivity of a thermal insulation material (TIM) of the IC;

FIG. 10 is a graph illustrating an exemplary relationship between a temperature estimation of an IC block in an IC and a heat transfer coefficient of a heat sink of the IC;

FIG. 11 illustrates another embodiment of an IC formed in an electronic package, which is one embodiment of the IC shown in FIG. 1; and

FIG. 12 is a block diagram of an exemplary processor-based system that can include the ICs having the DTEs disclosed herein.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include digital temperature estimators (DTEs) disposed in integrated circuits (ICs) for estimating temperature within the ICs. Related systems and methods are also disclosed. In one embodiment, the DTEs can be used to estimate temperatures in an integrated circuit (IC) by implementing a temperature estimation model (TEM). The TEM can provide an estimated temperature of an IC block disposed in the IC based on activity event(s) associated with the IC block, as opposed to providing temperature sensors in the IC to measure temperature of the IC block directly. Implementation of the TEM allows for temperatures in the IC and IC blocks disposed therein to be estimated even if the temperatures of the IC are highly non-linear with respect to power consumption in the IC. The DTEs can be operated in real time so that power and/or thermal regulation systems of the IC can obtain accurate and reliable temperature estimation from the DTE. In this manner, the thermal dissipation in the IC may be regulated more effectively. For example, power consumption in the IC may be controlled more precisely to maintain the IC within desired temperature limits. As another example, voltage scaling performed in the IC based on the estimated temperature may be provided more accurately.

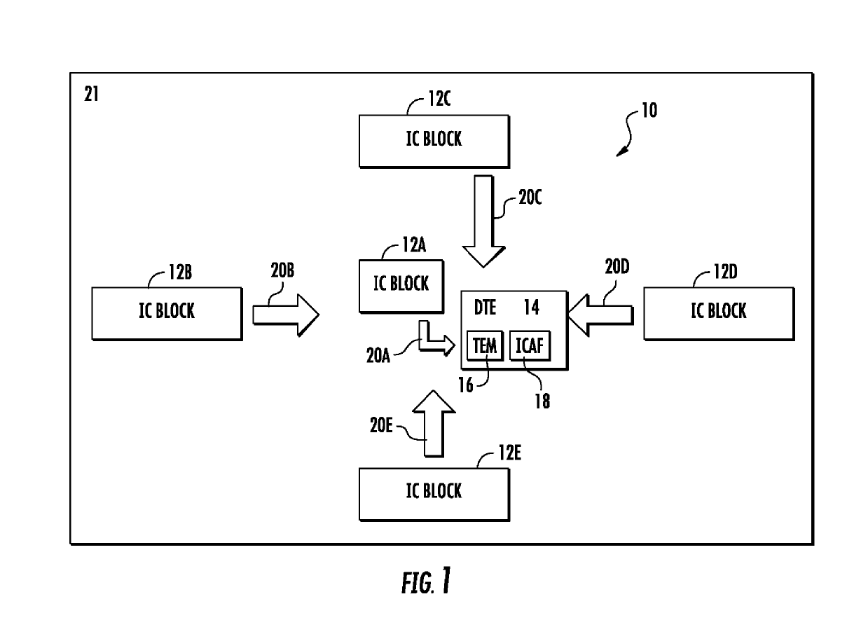

In this regard, FIG. 1 illustrates one embodiment of an IC 10 that includes a plurality of IC blocks (referred to generically as elements 12 and specifically as elements 12A-12E) and a DTE 14. The IC blocks 12 may have any type of functionality. For instance, one or more of the IC blocks 12 may be a digital functional block such as one or more microprocessors; one or more volatile and/or non-volatile memory blocks; decoding circuits, encoding circuits, clock-generation circuits, and/or other types of sequencing circuits; flip-flops; latches; analog-to-digital circuits; and/or any other type of circuit that utilizes, processes, and/or receives digital information. One or more of the IC blocks 12 may also be an analog functional block. Exemplary analog functional blocks include, but are not limited to, digital-to-analog converters, amplification circuits, filtering circuits, analog control circuits, power regulation circuits, switching circuits, charge pumps, other types of analog power circuits, and/or the like. Alternatively, one or more of the IC blocks 12 may include both one or more digital functional circuits and one or more analog functional circuits.

With continuing reference to FIG. 1, the DTE 14 has a temperature estimation model (TEM) 16. The DTE 14 is configured to obtain IC block activity events associated with the plurality of IC blocks 12 in real time. In this embodiment, the DTE 14 stores the IC block activity events in an IC block activity file (ICAF) 18. The DTE 14 is configured to implement the TEM 16 to calculate one or more temperature estimations that estimate a temperature of one or more of the plurality of IC blocks 12 as a function of the IC block activity events stored in the ICAF 18. Thus, as shown in FIG. 1, the IC blocks 12 include an IC block 12A, an IC block 12B, an IC block 12C, an IC block 12D, an IC block 12E, and another IC block comprising the DTE 14.

The temperature estimations calculated during an estimation cycle by implementing the TEM 16 are a function of the IC block activity events stored in the ICAF 18. By implementing the TEM 16, the DTE 14 can calculate temperature estimations for any subset of the plurality of IC blocks 12. For example, during any estimation cycle, the DTE 14 may implement the TEM 16 and calculate a temperature estimation that estimates the temperature of just the IC block 12A. Additionally, during any estimation cycle, the DTE 14 may implement the TEM 16 and calculate a temperature estimation that estimates the temperature of just the IC block 12B. During any estimation cycle, the DTE 14 may implement the TEM 16 and calculate a temperature estimation that estimates the temperature of just the IC block 12C. During any estimation cycle, the DTE 14 may implement the TEM 16 and calculate a temperature estimation that estimates the temperature of just the IC block 12D. Also, during any estimation cycle, the DTE 14 may implement the TEM 16 and calculate a temperature estimation that estimates the temperature of just the IC block 12E. Additionally, the DTE 14 may implement the TEM 16 and calculate temperature estimations for all of the IC blocks 12A-12E. Finally, the DTE 14 may implement the TEM 16 to estimate temperatures for more than one but fewer than all of the IC blocks 12A-12F (e.g., temperature estimations for the IC blocks 12A, 12B).

The IC block activity events stored in the ICAF 18 may be updated during each of the estimation cycles. Thus, by implementing the TEM 16 during each of the estimation cycles, the DTE 14 calculates the temperature estimation(s) for one or more of the IC blocks 12 in real time. In this embodiment, the ICAF 18 is configured to receive activity event information (referred to generically as element 20 and specifically as elements 20A, 20B, 20C, 20D, 20E) associated with the plurality of IC blocks 12 in real time during operation of the IC 10. More specifically, the IC block 12A is configured to transmit activity event information 20A to the DTE 14. The IC block 12B is configured to transmit activity event information 20B to the DTE 14. The IC block 12C is configured to transmit activity event information 20C to the DTE 14. The IC block 12D is configured to transmit activity event information 20D to the DTE 14. Finally, the IC block 12E is configured to transmit activity event information 20E to the DTE 14.

The IC blocks 12 consume certain quantities of power when performing activities. The amount of heat generated by the IC blocks 12 is determined by the activities performed by the IC blocks 12. Using the activity event information 20, the IC block activity events describe and quantify the activities performed by the IC blocks 12. Power consumption and temperature based on the activities of the IC blocks 12 can be determined through empirical testing, which can then be used to determine models to estimate temperature of the IC blocks 12 based on the activity event information 20 relating to the IC blocks 12. As explained in further detail below, the IC block activity events may describe the various types of activities performed by the IC blocks 12, such as on/off activity, frequencies of operation, block operations, and/or the like. The TEM 16 may thus use the IC block activity events to calculate temperature estimation(s). More specifically, since the activities performed by the IC blocks 12 affect the amount of heat generated by the IC blocks 12, the DTE 14 can implement the TEM 16 to calculate the temperature estimation(s) for one or more of the IC blocks 12 as a function of the IC block activity events.

The IC block activity events may be performance variables, but do not include direct measurements of temperature that require temperature sensors, or direct measurements of power consumption, generated voltages, or current consumption in certain embodiments disclosed herein. The IC block activity events stored in the ICAF 18 are based on the activity event information 20. For example, some or all of the activity event information 20 may be received as some or all of the IC block activity events themselves. In this case, the activity event information 20 is simply stored in the ICAF 18 as the IC block activity events for the estimation cycle. An IC block activity event may be any type of data variable that can be used either directly or indirectly to estimate temperature. The IC block activity events may include frequency variables and/or any other type of performance variable that can be utilized to estimate temperature. Additionally or alternatively, some or all of the activity event information 20 may be utilized to determine the IC block activity events stored in the ICAF 18 for each estimation cycle. For instance, the activity event information 20 may include event increments. Each of the event increments can indicate when a particular performance activity has been implemented by one of the IC blocks 12. These performance activities may be the execution of an instruction, the number of times a component or IC block 12 has been switched on or off, a memory miss, a switching event, a mode transition, a task, and/or any other type of hardware-related activity or software-related activity.

To update the IC block activity events stored in the ICAF 18, some or all of the IC block activity events stored in the ICAF 18 may be incremented in accordance with the event increments. For example, event increments may be received for any of the IC block activity events described above. The IC block activity events stored in the ICAF 18 may then be incremented in accordance with the event increments, thereby updating the ICAF 18 in real time. The IC block activity event may thus describe the performance variable(s) updated by the event increment(s) during the current and/or previous estimation cycle (or portions thereof). Alternatively or additionally, the IC block activity event may describe the performance variable(s) updated by the event increment(s) from the beginning of operation until the current and/or previous estimation cycle.

The IC 10 may be an IC chip provided in an electronic package (not shown). The electronic package may include one or more semiconductor dies 21, as explained in further detail below. The IC blocks 12 may be formed on the semiconductor die 21 and may be functional blocks in the IC 10.

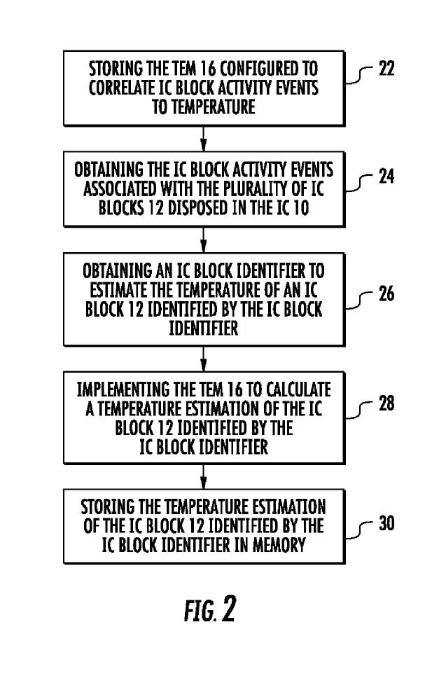

FIG. 2 illustrates one embodiment of a temperature estimation method that may be performed by the DTE 14 shown in FIG. 1. The DTE 14 stores the TEM 16 configured to correlate IC block activity events to temperature (block 22). For example, the TEM 16 may have been loaded into the DTE 14 by a fabricator or, later, by an end user. The TEM 16 may then be stored in a non-transitory computer-readable medium within the DTE 14. In this manner, the TEM 16 may be utilized to determine temperature estimations for the IC blocks 12 in real time. During operation of one or more of the IC blocks 12, the ICAF 18 obtains the IC block activity events associated with the plurality of the IC blocks 12 disposed in the IC 10 (block 24). The ICAF 18 may obtain the IC block activity events in real time. As such, the IC block activity events stored by the ICAF 18 may be updated during estimation cycles.

For example, during an estimation cycle, or during temporally adjacent estimation cycles, the ICAF 18 may receive the activity event information 20 associated with the IC blocks 12. The activity event information 20 is received in real time and may be continually received throughout at least a portion of the estimation cycle and/or adjacent estimation cycles. The IC block activity events stored by the ICAF 18 may be continuously updated by the activity event information 20 and/or may be based on all of the activity event information 20 received until a particular temporal location in the estimation cycle.

In one embodiment, at least some of the activity event information 20 may be received as event increments. Thus, at least some of the IC block activity events stored by the ICAF 18 may be accumulations of the corresponding event increments received within the activity event information 20. More specifically, the ICAF 18 may increment at least some of the IC block activity events in accordance with the event increments in real time. The ICAF 18 may be configured to increment at least some of the IC block activity events continuously in accordance with the event increments from the activity event information 20 throughout the estimation cycle. In one embodiment, the IC block activity events utilized to implement the TEM 16 are read from the ICAF 18 during a beginning of the next estimation cycle or, alternatively, at some other temporal location during the next estimation cycle. In yet another embodiment, the temporal location for reading the IC block activity event from the ICAF 18 may vary from estimation cycle to estimation cycle.

Additionally and/or alternatively, at least some of the activity event information 20 may also be received as at least some of the IC block activity events themselves. For example, the IC blocks 12 may be configured to each transmit an IC block activity event in the activity event information 20 once during each estimation cycle. These IC block activity events may be received by the ICAF 18 and stored therein.

The DTE 14 may then obtain an IC block identifier to estimate the temperature of an IC block 12 identified by the IC block identifier (block 26). Thus, an IC block identifier identifying the IC block 12A may be obtained to estimate the temperature of the IC block 12A. An IC block identifier identifying the IC block 12B may be obtained to estimate the temperature of the IC block 12B. An IC block identifier identifying the IC block 12C may be obtained to estimate the temperature of the IC block 12C. An IC block identifier identifying the IC block 12D may be obtained to estimate the temperature of the IC block 12D. Finally, an IC block identifier identifying the IC block 12E may be obtained to estimate the temperature of the IC block 12E. Additionally and/or alternatively, IC block identifiers for all of the IC blocks 12 may be received to estimate the temperatures of all of the IC blocks 12. Also, additionally and/or alternatively, a subset of IC block identifiers may be obtained to estimate the temperatures of a subset of the IC blocks 12.

The DTE 14 may then implement the TEM 16 to calculate a temperature estimation of the IC block 12 identified by the IC block identifier (block 28). For example, if only one IC block identifier is obtained, then the TEM 16 is implemented to calculate a temperature estimation of just the IC block 12 identified by the IC block identifier. Thus, the temperature estimation may estimate the temperature of the IC block 12A, the IC block 12B, the IC block 12C, the IC block 12D, or the IC block 12E, depending on which of these IC blocks 12 was identified by the IC block identifier. Additionally and/or alternatively, if IC block identifiers are received for all of the IC blocks 12, then the DTE 14 may implement the TEM 16 to calculate temperature estimations for all of the IC blocks 12. The temperature estimations would thus correspond bijectively to the IC blocks 12 and the IC block identifiers. Additionally and/or alternatively, if IC block identifiers are obtained that identify a proper subset of the IC blocks 12, then the DTE 14 may implement the TEM 16 to calculate temperature estimations of the proper subset of the IC blocks 12 identified by the IC block identifiers. The DTE 14 implements the TEM 16 in real time, and thus during operation of one or more of the IC blocks 12. For example, the DTE 14 may implement the TEM 16 at least once during every estimation cycle.

The TEM 16 used to calculate the temperature estimations may be a single overall computer model or may include various computer submodels. In one exemplary embodiment, the TEM 16 includes both a power estimation submodel and a temperature estimation submodel. Accordingly, when the DTE 14 implements the TEM 16 to calculate the temperature estimation(s), the DTE 14 may first implement the power estimation submodel and calculate power estimations for the IC blocks 12. The power estimations may correspond injectively with the plurality of IC blocks 12 based on the IC block activity events read from the ICAF 18 during an estimation cycle. Thus, each of the power estimations estimates power consumption of a corresponding one of the IC blocks 12. The power estimations may also correspond surjectively with the plurality of IC blocks 12. In this case, when the power estimations correspond injectively and surjectively with the plurality of IC blocks 12, the power estimations correspond bijectively with the plurality of IC blocks 12.

Once the power estimations are calculated, the DTE 14 implements the temperature estimation submodel to calculate the temperature estimation(s) based on the power estimations. In this manner, the temperature estimation(s) may be calculated in real time. The temperature estimation(s) may be calculated based on the power estimations at least once during every estimation cycle. The DTE 14 may store the temperature estimation of the IC block 12 identified by the IC block identifier in memory (block 30). If more than one IC block identifier was obtained in block 26, then the various temperature estimations of the IC blocks 12 identified by the IC block identifiers are stored in memory. Additionally, the power estimations may also be stored in memory by the DTE 14. The DTE 14 may be configured to store the temperature estimations and the power estimations in memory in real time. For example, the DTE 14 may be configured to store the temperature estimations and the power estimations in the memory at least once during every estimation cycle. Note that blocks 24, 26, 28, and 30 may be repeated during every estimation cycle. In this manner, the DTE 14 calculates the temperature estimations and the power estimations in real time as the operation of the IC blocks 12 progresses through time. The temperature estimations and the power estimations stored in the memory of the DTE 14 may thus be utilized to regulate the IC 10 as the temperature estimations and the power estimations progress through time. For example, the temperature estimations and the power estimations may be utilized to scale voltages within the IC 10. The temperature estimations and the power estimations may also be utilized to provide task scheduling and to regulate power within the IC 10.

The IC block activity events used to implement the TEM 16 can provide a multitude of different performance variables in order to determine the temperature estimations and the power estimations with a desired degree of accuracy. For instance, the IC block activity events can be performance variables that are idiosyncratic with respect to each of the IC blocks 12, and thus the IC block activity events can capture non-generic performance variables that are significant in calculating the temperature estimations and the power estimations for any of the IC blocks 12. As explained in further detail below, the TEM 16 can also be specifically tailored to the IC 10. In this manner, the DTE 14 can provide the temperature estimations and the power estimations with a high degree of accuracy.

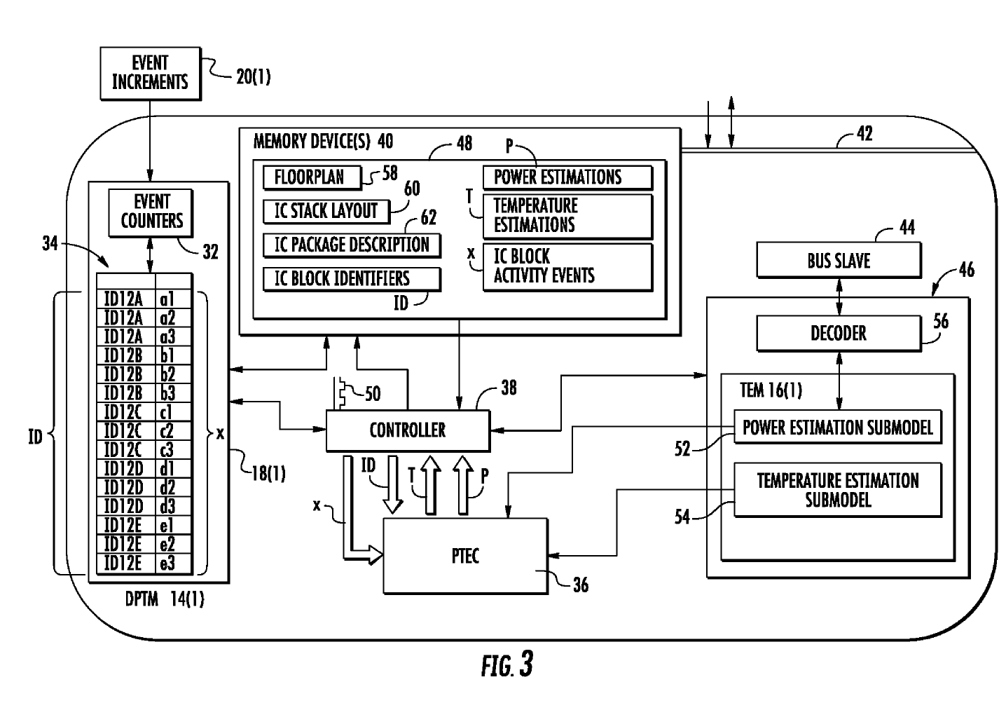

FIG. 3 illustrates one embodiment of a digital power and temperature module (DPTM) 14(1), which is one embodiment of the DTE 14 shown in FIG. 1. The DPTM 14(1) has a TEM 16(1), which is one embodiment of the TEM 16 described above with respect to FIG. 1, and includes an ICAF 18(1), which is one embodiment of the ICAF 18 shown in FIG. 1. The ICAF 18(1) is configured to store IC block activity events (referred to generically as elements x and specifically as elements a1, a2, a3, b1, b2, b3, d1, d2, d3, e1, e2, e3) associated with the IC blocks 12 disposed in the IC 10 shown in FIG. 1. More specifically, the IC block activity events a1, a2, and a3 are the IC block activity events x associated with the IC block 12A shown in FIG. 1. The IC block activity events b1, b2, and b3 are the IC block activity events x associated with the IC block 12B shown in FIG. 1. The IC block activity events c1, c2, and c3 are the IC block activity events x associated with the IC block 12C shown in FIG. 1. The IC block activity events d1, d2, and d3 are the IC block activity events x associated with the IC block 12D shown in FIG. 1. Finally, the IC block activity events e1, e2, and e3 are the IC block activity events x associated with the IC block 12E shown in FIG. 1.

In this embodiment, the ICAF 18(1) is configured to receive event increments 20(1), which are one embodiment of the activity event information 20 described above with respect to FIG. 1. The IC block activity events x are based on the event increments 20(1). In this embodiment, the ICAF 18(1) includes event counters 32 and event registers 34. The event registers 34 are configured to store the IC block activity events x. The event registers 34 are also configured to store the IC block identifiers (referred to generically as elements ID and specifically as elements ID12A, ID12B, ID12C, ID12D, and ID12E). For example, an IC block identifier ID12A identifies the IC block 12A shown in FIG. 1. Furthermore, an IC block identifier ID12B identifies the IC block 12B shown in FIG. 1. Additionally, an IC block identifier ID12C identifies the IC block 12C shown in FIG. 1. Also, an IC block identifier ID12D identifies the IC block 12D shown in FIG. 1. Finally, an IC block identifier ID12E identifies the IC block 12E shown in FIG. 1.

The IC block identifiers ID in the event registers 34 therefore indicate which of the IC blocks 12 (shown in FIG. 1) is associated with each of the IC block activity events x. The event counters 32 are configured to increment the IC block activity events x stored in the event registers 34 in accordance with the event increments 20(1) in real time. For example, the ICAF 18(1) may be configured to increment the IC block activity events x stored in the event registers 34 in accordance with the event increments 20(1) throughout an estimation cycle. The IC block activity events a1, a2, a3, b1, b2, b3, c1, c2, c3, d1, d2, d3, e1, e2, and e3 may each be performance variables, such as activity counts, which are also incremented by the event counters 32 in accordance with associated event increments provided in the event increments 20(1).

As shown in FIG. 3, the DPTM 14(1) also includes a power and temperature estimation calculator (PTEC) 36, a controller 38, one or more memory devices 40, a bus 42, a bus slave 44, and a register file 46. The PTEC 36 is configured to receive the IC block identifier ID from the controller 38 to estimate the temperature of at least one of the IC blocks 12 (shown in FIG. 1) identified by the IC block identifier ID. More specifically, the PTEC 36 may receive a set of the IC block identifiers ID to estimate temperatures of the IC blocks 12 identified by the set of the IC block identifiers ID. The set of the IC block identifiers ID received from the controller 38 can thus include any number of the IC block identifiers ID to estimate temperatures for any number of the IC blocks 12 identified by the set of the IC block identifiers ID.

The PTEC 36 is configured to implement the TEM 16(1) to calculate a temperature estimation T of the IC block 12 identified by the IC block identifier ID received from the controller 38. More specifically, the PTEC 36 is configured to implement the TEM 16(1) to calculate temperature estimations (referred to generically as element T and specifically as elements T_{A}, T_{B}, T_{C}, T_{D}, and T_{E}) of the set of the IC blocks 12 identified by the IC block identifiers ID received from the controller 38. A temperature estimation T_{A} estimates a temperature of the IC block 12A. Furthermore, a temperature estimation T_{B} estimates a temperature of the IC block 12B. Additionally, a temperature estimation T_{C} estimates a temperature of the IC block 12C. Also, a temperature estimation T_{D} estimates a temperature of the IC block 12D. Finally, a temperature estimation T_{E} estimates a temperature of the IC block 12E. The PTEC 36 is configured to cause the temperature estimation T of the IC block 12 identified by the IC block identifier ID to be stored in memory 48. The memory 48 is provided by the memory device(s) 40.

To calculate the temperature estimations T, the controller 38 is configured to initiate a temperature estimation operation for the IC blocks 12. The temperature estimation operation is the procedures performed by the DPTM 14(1) during each of the estimation cycles. In this embodiment, the controller 38 receives a clock signal 50 to synchronize the estimation operations. In this manner, each of the estimation operations is provided during a consistent estimation cycle and the functionality of the DPTM 14(1) can be coordinated in real time.

Once the estimation operation is initiated by the controller 38, the controller 38 is configured to receive the IC block activity events x from the ICAF 18(1). After initiation, the controller 38 may cause the IC block activity events x to be stored in the memory 48. Furthermore, the controller 38 is configured to transmit the IC block activity events x to the PTEC 36. In this embodiment, the PTEC 36 transmits the temperature estimations T to the controller 38 after the TEM 16(1) has been implemented. The controller 38 then may transmit write instructions to the memory device(s) 40 along with the temperature estimations T so that the memory device(s) 40 store the temperature estimations T in the memory 48.

As mentioned above, the TEM 16(1) is configured to correlate the IC block activity events x to temperature. In this embodiment, the TEM 16(1) includes a power estimation submodel 52 and a temperature estimation submodel 54. More specifically, the power estimation submodel 52 is configured to correlate the IC block activity events x to power while the temperature estimation submodel 54 is configured to correlate the power to the temperature. To calculate the temperature estimations T for the estimation cycle, the controller 38 is configured to send the IC block activity events x to the register file 46 through the bus slave 44. In this embodiment, the TEM 16(1) is a non-parametric regression computer model. More specifically, the TEM 16(1) is a Global Distribution System (GDS) model. Thus, the power estimation submodel 52 and the temperature estimation submodel 54 are each non-parametric regression computer models. The TEM 16(1) thus operates such that coefficients of the TEM 16(1) are based on the IC block activity events x. Furthermore, the TEM 16(1) includes predictors. These predictors are a system of equations that are utilized with selected coefficients to estimate the power and the temperature of the IC blocks 12. The register file 46 thus includes a decoder 56 that selects the coefficients to be utilized with the power estimation submodel 52 and the coefficients to be utilized with the temperature estimation submodel 54 in accordance with the IC block activity events x from the ICAF 18(1). In this manner, the TEM 16(1) has a labile form that changes in accordance with the IC block activity events x for the current estimation cycle.

Additionally, one or more topological descriptions describing a topology of the IC 10 may be integrated into the TEM 16(1) such that the TEM 16(1) further correlates the IC block activity events x to the temperature given the topological description(s). Once the decoder 56 has selected the coefficients based on the IC block activity events x, the controller 38 is configured to cause the register file 46 to load the TEM 16(1) into the PTEC 36. More specifically, the selected coefficients of the power estimation submodel 52, the selected coefficients of the temperature estimation submodel 54, and the predictors are loaded into the PTEC 36 by the controller 38.

As mentioned above, the controller 38 is configured to transmit the IC block activity events x to the PTEC 36. During the estimation cycle, the temperatures of one or more of the IC blocks 12 shown in FIG. 1 may be of interest to different control operations of the IC 10 shown in FIGS. 1 and 3. For the sake of clarity, it is presumed for the remainder of the discussion that the temperatures of all of the IC blocks 12 are of interest for the current estimation cycle. However, as discussed above, the temperatures of any subset of one or more of the IC blocks 12 shown in FIG. 1 may be of interest during particular current estimation cycles. Taking this caveat in mind with regard to the estimation cycle currently being discussed, the controller 38 transmits the IC block identifiers ID to the PTEC 36.

The PTEC 36 is configured to receive the IC block identifiers ID to estimate the temperatures of the IC blocks 12 identified by the IC block identifiers ID. Since the IC block activity events x and the TEM 16(1) have been loaded into the PTEC 36, the PTEC 36 implements the TEM 16(1). More specifically, the PTEC 36 is configured to implement the power estimation submodel 52 to calculate power estimations (referred to generically as elements P and specifically as elements P_{A}, P_{B}, P_{C}, P_{D}, and P_{E}) that correspond injectively with the plurality of IC blocks 12 shown in FIG. 1. Since it is assumed that all of the IC block identifiers ID were provided to the PTEC 36 for the current estimation cycle, the power estimations P also correspond surjectively with the plurality of IC blocks 12 shown in FIG. 1. More specifically, a power estimation P_{A} estimates power consumption in the IC block 12A. Furthermore, a power estimation P_{B} estimates power consumption in the IC block 12B. Additionally, a power estimation P_{C} estimates power consumption in the IC block 12C. Also, a power estimation P_{D} estimates power consumption in the IC block 12D. Finally, a power estimation P_{E} estimates power consumption in the IC block 12E.

In one embodiment, the power estimations P are power density estimations that estimate power densities in the IC blocks 12 of the IC 10 shown in FIG. 1. Furthermore, each of the power estimations P is correlated with the IC block activity events x received from the ICAF 18(1) for the current estimation cycle. Once the power estimations P are calculated based on the IC block activity events x, the PTEC 36 is configured to implement the temperature estimation submodel 54 to calculate the temperature estimations T of the IC blocks 12 identified by the IC block identifiers ID. As such, the temperature estimations T are correlated with the power estimations P calculated with the power estimation submodel 52.

The controller 38 is then configured to receive the temperature estimations T from the PTEC 36. The controller 38 may then transmit the power estimations P and/or the temperature estimations T to external circuitry via the bus 42 using the bus slave 44. In this manner, the IC 10 shown in FIG. 1 may utilize the power estimations P and the temperature estimations T to regulate power accordingly. The controller 38 is also configured to load the temperature estimations T and the power estimations P into the memory 48 of the memory device(s) 40.

As shown in FIG. 3, the controller 38 may be further configured to store topological descriptions describing a physical topology of the IC 10 shown in FIG. 1 in the memory 48. In this embodiment, the topological descriptions include a floorplan 58, an IC stack layout 60, and an IC package description 62. The floorplan 58 describes placement of the IC blocks 12 on one or more semiconductor dies of the IC 10 shown in FIG. 1. Thus, the floorplan 58 describes a planar placement of the IC blocks 12 shown in FIG. 1 on the one or more semiconductor dies. The IC stack layout 60 describes the stacked layers of the IC 10. In other words, the IC stack layout 60 describes a physical topology of the IC 10 that is orthogonal with respect to the planes defined by the one or more semiconductor dies. Additionally, the IC package description 62 describes a physical topology of an electronic package for the IC 10. The IC package description 62 may describe an electronic package type, material properties of the electronic package, and/or the like.

The controller 38 is configured to map the temperature estimations T to the topographical descriptions (i.e., the floorplan 58, the IC stack layout 60, and the IC package description 62). Note that the controller 38 loads the IC block identifiers ID into the memory 48 of the memory device(s) 40. These IC block identifiers ID can thus be mapped to descriptions of the IC blocks 12 of the IC 10 shown in FIG. 1. The controller 38 may also map the power estimations P to the topographical descriptions (i.e., the floorplan 58, the IC stack layout 60, and the IC package description 62). Thus, information regarding the power estimations P, the temperature estimations T, and the areas that are relevant to the power estimations P and the temperature estimations T are stored in the memory 48 by the controller 38.

Note that the floorplan 58, the IC stack layout 60, and the IC package description 62 may already be integrated into the TEM 16(1) and do not have to be used during the implementation of the TEM 16(1). The power estimation submodel 52 thus correlates the IC block activity events x to the power and the temperature estimation submodel 54 correlates the power to the temperature given the topographical descriptions (i.e., the floorplan 58, the IC stack layout 60, and the IC package description 62). Accordingly, the coefficients of the TEM 16(1) are provided given the physical topology of the IC 10. The power estimations P and the temperature estimations T thus take into account the physical topology of the IC 10 shown in FIG. 1.

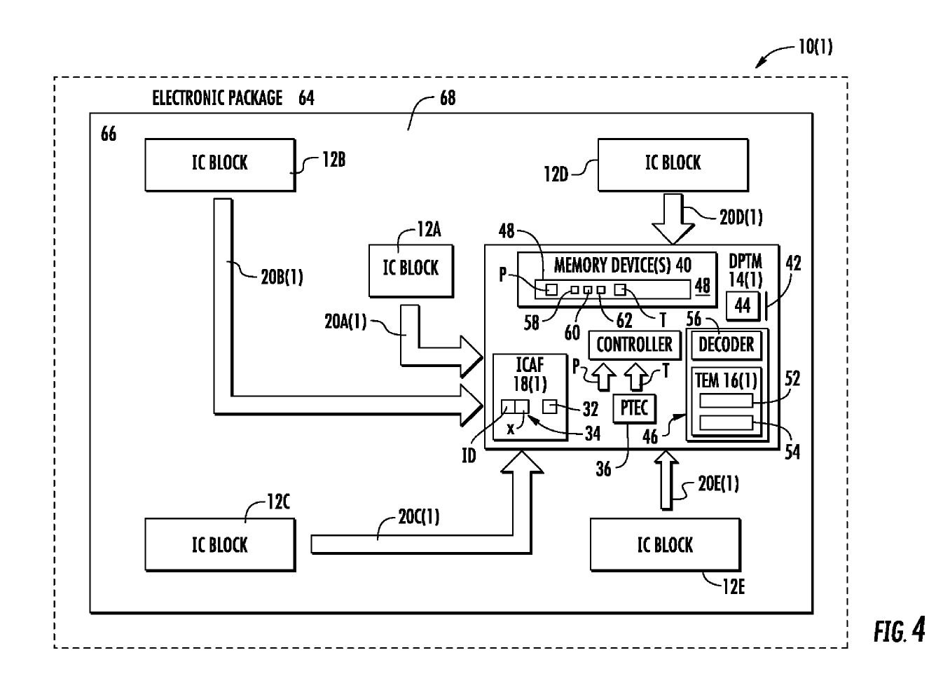

FIG. 4 illustrates one embodiment of an IC 10(1) which is one embodiment of the IC 10 shown in FIG. 1. The IC 10(1) shown in FIG. 4 includes the IC blocks 12 shown in FIG. 1 and the DPTM 14(1) shown in FIG. 3. The DPTM 14(1) thus receives the event increments 20(1) shown in FIG. 3. In this embodiment, the IC block 12A transmits the activity event information 20A shown in FIG. 1 as event increments 20A(1), which are the event increments 20(1) that come from the IC block 12A. In this embodiment, the IC block 12B transmits the activity event information 20B shown in FIG. 1 as event increments 20B(1), which are the event increments 20(1) that come from the IC block 12B. In this embodiment, the IC block 12C transmits the activity event information 20C shown in FIG. 1 as event increments 20C(1), which are the event increments 20(1) that come from the IC block 12C. In this embodiment, the IC block 12D transmits the activity event information 20D shown in FIG. 1 as event increments 20D(1), which are the event increments 20(1) that come from the IC block 12D. Finally, in this embodiment, the IC block 12E transmits the activity event information 20E shown in FIG. 1 as event increments 20E(1), which is the event increments 20(1) that come from the IC block 12E.

As shown in FIG. 4, the IC 10(1) is integrated into an electronic package 64 that includes a semiconductor die 66. In this embodiment, the IC blocks 12 are formed on the semiconductor die 66 such that the IC 10(1) has a two-dimensional (2-D) topology. More specifically, each of the IC blocks 12 is formed at a surface 68 of the semiconductor die 66. The surface 68 may be an obverse surface of the semiconductor die 66 where active components are formed. The floorplan 58 describes the placement of the IC blocks 12 on the surface 68 of the semiconductor die 66. As discussed above, the floorplan 58 has been integrated into the TEM 16(1) so that coefficients in the TEM 16(1) have been determined in accordance with the floorplan 58.

The IC blocks 12 transmit the event increments 20(1) to the DPTM 14(1) through a back end of line (BEOL) (not shown) provided by the IC 10(1). The DPTM 14(1) thereby receives the event increments 20(1) from the BEOL at the event counters 32. With regard to the vertical physical topology of the IC 10(1), the IC stack layout 60 describes the vertical stacking of layers in the semiconductor die 66 and the BEOL. As explained above, the IC stack layout 60 has been integrated into the TEM 16(1). The electronic package 64 may also include a thermal interface material (TIM) (not shown) and a heat sink (not shown). The electronic package 64 may also include a package substrate (not shown) and encapsulation material (not shown) that encapsulates the semiconductor die 66 and the BEOL. For example, as explained in further detail below, the BEOL may be mounted on the package substrate while the TEM 16(1) is provided between the semiconductor die 66 and the heat sink. The package substrate is mountable on a printed circuit board in order to couple the IC 10(1) to other external ICs. The IC package description 62 describes a topology of the electronic package 64, and may also describe material properties, package type, and/or any other descriptor relevant to the structure of the electronic package 64.

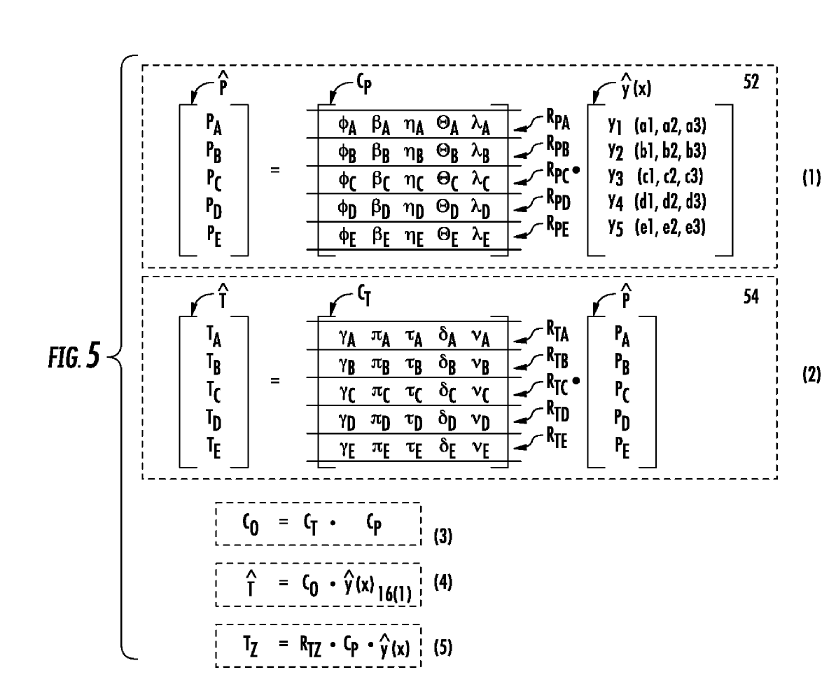

Referring now to FIGS. 4 and 5, FIG. 5 illustrates mathematical expressions relevant to the implementation of the TEM 16(1) by the PTEC 36. More specifically, a mathematical expression (1) shown in FIG. 5 describes the implementation of the power estimation submodel 52 by the PTEC 36. The power estimations P calculated by the implementation of the power estimation submodel 52 are in a vector form, as indicated by the ̂ symbol. The power estimations P are a function of a power coefficient matrix C_{P} and a predictor vector ŷ(x). More specifically, the predictor vector ŷ(x) is a function of the IC block activity events x. As indicated by the mathematical expression (1), the predictor vector ŷ(x) is a column of predictors y₁, y₂, y₃, y₄, and y₅. The predictor y₁ is a function of the IC block activity events a₁, a₂, a₃ for the IC block 12A. The predictor y₂ is a function of the IC block activity events b₁, b₂, b₃ for the IC block 12B. The predictor y₃ is a function of the IC block activity events c₁, c₂, c₃ for the IC block 12C. The predictor y₄ is a function of the IC block activity events d₁, d₂, d₃ for the IC block 12D. Finally, the predictor y₅ is a function of the IC block activity events e₁, e₂, e₃ for the IC block 12E.

In one embodiment, each of the predictors y₁, y₂, y₃, y₄, y₅ in the predictor vector ŷ(x) is a polynomial. However, the predictors y₁, y₂, y₃, y₄, y₅ may also be any type of suitable function or combination of functions, such as integrals, derivatives, Gaussian distribution functions, pulse functions, triangular functions, quartic functions, Epanechnikov functions, trigonometric functions, tricube functions, statistical functions, and/or the like.

The power coefficient matrix C_{P} is multiplied by the predictor vector ŷ(x) in order to calculate the power estimations P. In this embodiment, the power coefficient matrix C_{P} is a 5×5 matrix of coefficients. As explained above, the decoder 56 is configured to select the coefficients in the power coefficient matrix C_{P} based on the IC block activity events x received from the ICAF 18(1) for the current estimation cycle. The decoder 56 may also select the coefficients of the power coefficient matrix C_{P} based on prior power estimations P, temperature estimations T, and/or IC block activity events x. The coefficients in the power coefficient matrix C_{P} have been evaluated given the physical topology of the IC 10(1). In this manner, the topological descriptions (i.e., the floorplan 58, the IC stack layout 60, and the IC package description 62) are integrated into the power estimation submodel 52.

As shown by the mathematical expression (1), the power coefficient matrix C_{P} has a first row R_{PA} of coefficients. The power estimation P_{A} is equal to the first row R_{PA} times the predictor vector ŷ(x). A second row R_{PB} of coefficients of the power coefficient matrix C_{P} is multiplied times the predictor vector ŷ(x) to calculate the power estimation P_{B}. A row of coefficients R_{PC} of coefficients of the power coefficient matrix C_{P} is multiplied times the predictor vector ŷ(x) to calculate the power estimation P_{C}. A fourth row R_{PD} of coefficients of the power coefficient matrix C_{P} is multiplied times the predictor vector ŷ(x) to calculate the power estimation P_{D}. Finally, a fifth row R_{PE} of coefficients of the power coefficient matrix C_{P} is multiplied times the predictor vector ŷ(x) to calculate the power estimation P_{E}. In one embodiment, the power estimations P are each power density estimations that estimate a power density of the IC blocks 12 in the IC 10(1). However, each of the power estimations P may be of any type of power estimation that estimates power consumption of the IC blocks 12 in the IC 10(1).

Mathematical expression (2) in FIG. 5 is a mathematical expression that describes the implementation of the temperature estimation submodel 54 by the PTEC 36. The temperature estimations T calculated by the implementation of the temperature estimation submodel 54 are expressed in the mathematical expression (2) as a vector, which is indicated by the ̂ symbol. To calculate the temperature estimations T, a temperature coefficient matrix C_{T} is multiplied by the power estimations P (which, in this example, are expressed as vectors). In this embodiment, the temperature coefficient matrix C_{T} is a 5×5 matrix of coefficients. A physical topology of the IC 10(1) has been integrated into the temperature estimation submodel 54. Therefore, valuations of the coefficients in the temperature coefficient matrix C_{T} have been determined given one or more topographical descriptions (i.e., the floorplan 58, the IC stack layout 60, and the IC package description 62). Thus, the valuation of the coefficient in the temperature coefficient matrix C_{T} may have been provided given displacements between the IC blocks 12. Furthermore, material properties of the electronic package 64 may be integrated into the temperature estimation submodel 54. For example, the valuation of the coefficients in the temperature coefficient matrix C_{T} may have been determined given a thermal conductivity k of the TIM and a heat transfer coefficient h that indicates a capability of the heat sink to transfer heat from the electronic package 64.

The coefficients of the temperature coefficient matrix C_{T} may be selected by the decoder 56 based on the IC block activity events x received from the ICAF 18(1) for the current estimation cycle. Coefficients in a first row R_{TA} are multiplied by the power estimations P to calculate the temperature estimation T_{A}. Coefficients in a second row R_{TB} of the temperature coefficient matrix C_{T} are multiplied times the power estimations P to calculate the temperature estimation T_{B}. Coefficients in a third row R_{TC} of the temperature coefficient matrix C_{T} are multiplied times the power estimations P to calculate the temperature estimation T_{C}. Coefficients in a fourth row R_{TD} of the temperature coefficient matrix C_{T} are multiplied times the power estimations P to calculate the temperature estimation T_{D}. Coefficients in a fifth row R_{TE} of the temperature coefficient matrix C_{T} are multiplied times the power estimations P to calculate the temperature estimation T_{E}.

Mathematical expression (3) in FIG. 5 is a mathematical expression describing the calculation of a coefficient matrix C_{O}, which is equal to the temperature coefficient matrix C_{T} multiplied times the power coefficient matrix C_{P}. Since matrix multiplication is associative, mathematical expression (4) describes the implementation of the TEM 16(1) to calculate the temperature estimations T (where T is expressed as a vector, as indicated by the ̂). Note that in an alternative embodiment, the TEM 16(1) may be implemented directly through the mathematical expression (4) if the temperature estimations T are calculated without the calculation of the intermediary power estimations P. As mentioned above, the description of the implementation of the TEM 16(1) assumes that temperature estimations T are being calculated for all of the IC blocks 12. However, any subset of one or more of the temperature estimations T_{A}, T_{B}, T_{C}, T_{D}, and T_{E} may be calculated during the current estimation cycle. Mathematical expression (5) in FIG. 5 is a mathematical expression that describes the calculation of just one of the temperature estimations T_{Z} (where Z can be any one of A, B, C, D, E). More specifically, T_{Z} is equal to the row R_{TZ} of the temperature coefficient matrix C_{T} multiplied by the power coefficient matrix C_{P} and multiplied by the predictor vector ŷ(x). Thus, the mathematical expression (5) may be implemented by the PTEC 36 to calculate any one of the individual temperature estimations T_{A}, T_{B}, T_{C}, T_{D}, T_{E}, if only a subset of the IC block identifiers ID is received by the PTEC 36 from the controller 38 during the current estimation cycle.

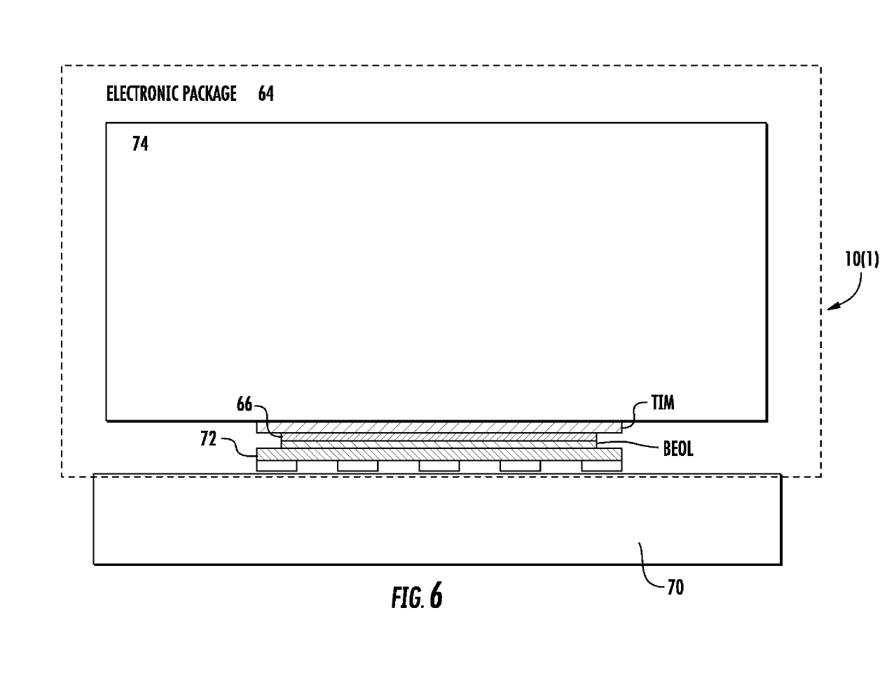

In order to more thoroughly describe an exemplary configuration of the IC 10(1) in FIG. 4, FIG. 6 illustrates an exemplary cross-section of the IC 10(1) integrated into the electronic package 64. In FIG. 6, the electronic package 64 is mounted on a printed circuit board 70. More specifically, a package substrate 72 of the electronic package 64 mounts the IC 10(1) on the printed circuit board 70. A BEOL of the electronic package 64 is provided between the semiconductor die 66 and the package substrate 72. The semiconductor die 66 is attached to a TIM so that the TIM is between the semiconductor die 66 and a heat sink 74. The thermal conductivity k is of the TIM, while the heat transfer coefficient h is of the heat sink 74.

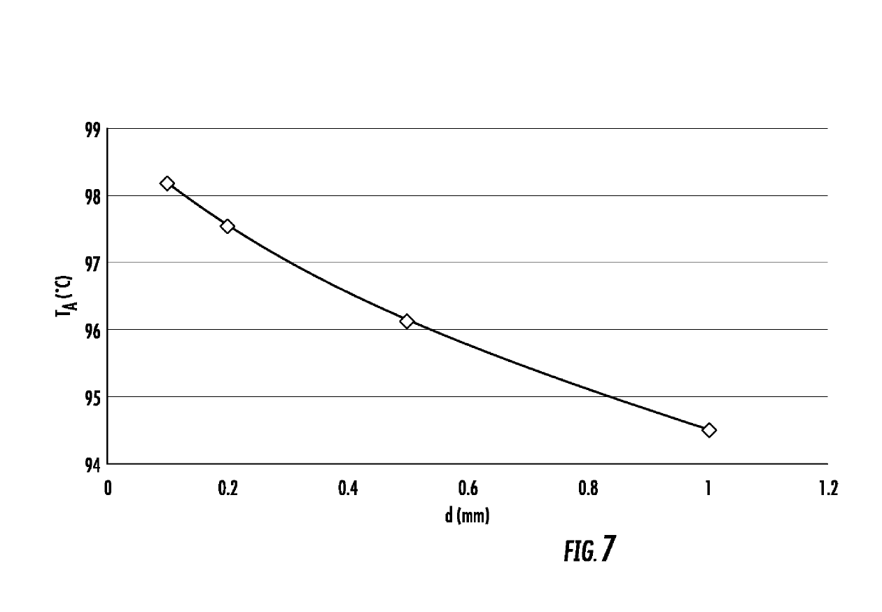

Referring now to FIG. 4 and FIG. 7, FIG. 7 is a graph that illustrates a relationship between the temperature estimation T_{A} of the IC block 12A and a displacement d between the IC block 12A and the IC block 12B. The graph shown in FIG. 7 thus helps describe how the physical topology of the IC 10(1) shown in FIG. 4 can be integrated into the TEM 16(1). As the graph in FIG. 7 clearly illustrates, the temperature estimation T_{A} decreases as the displacement d increases. This clearly demonstrates that less heat is transferred from the IC block 12B to the IC block 12A as the displacement d increases. Clearly, the displacement d is fixed in the IC 10(1) shown in FIG. 4. As such, the coefficients in the power coefficient matrix C_{P}, the coefficients in the temperature coefficient matrix C_{T}, and the coefficients in the coefficient matrix C_{O} shown in FIG. 5 are valuated given the particular displacement d of the IC 10(1) shown in FIG. 4 between the IC block 12A and the IC block 12B. In this manner, the displacement d is integrated into the TEM 16(1) in order to calculate the temperature estimation T_{A} of the IC block 12A given the particular displacement d.

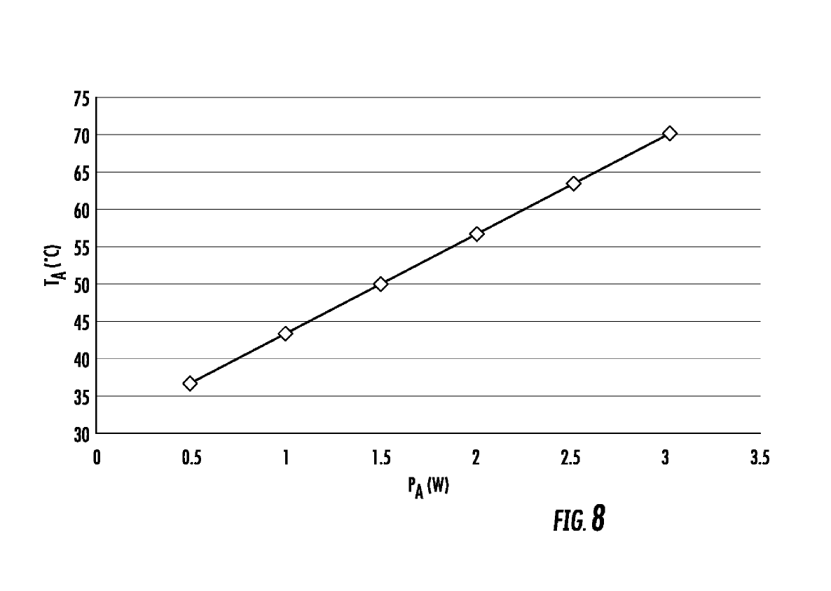

Referring now to FIG. 4 and FIG. 8, FIG. 8 illustrates a graph that describes an exemplary relationship between the temperature estimation T_{A} of the IC block 12A and the power estimation P_{A} of the IC block 12A. In this embodiment, the power estimation P_{B} of the IC block 12B, the power estimation P_{C} of the IC block 12C, the power estimation P_{D} of the IC block 12D, and the power estimation P_{E} of the IC block 12E shown in FIG. 4 are held constant for the sake of simplicity. As shown in FIG. 8, as the power estimation P_{A} increases, so does the temperature estimation T_{A} of the IC block 12A. This illustrates that the greater the power consumed by the IC block 12A, the more heat is generated, and thus, the greater the temperature of the IC block 12A. The first row R_{TA} of the temperature coefficient matrix C_{T} multiplied by the power estimations P shown in the mathematical expression (2) of FIG. 5 describes this relationship.

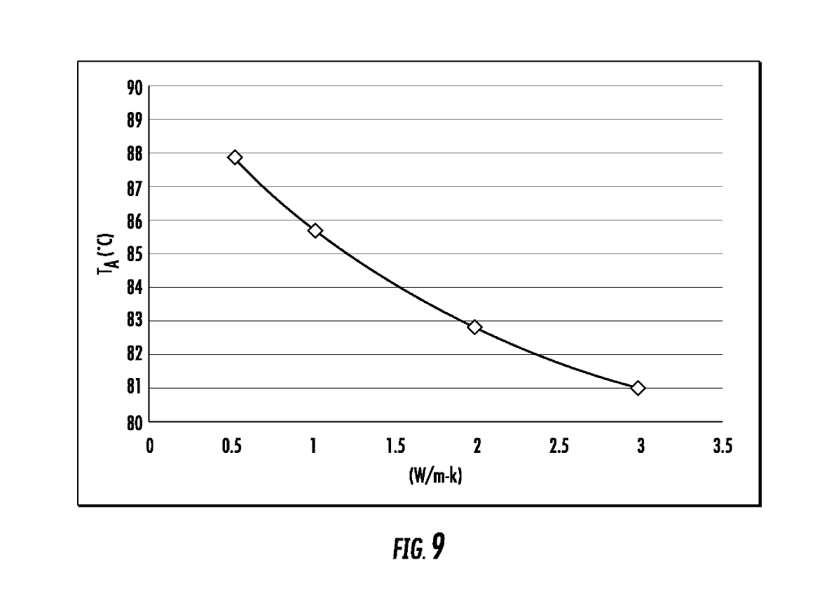

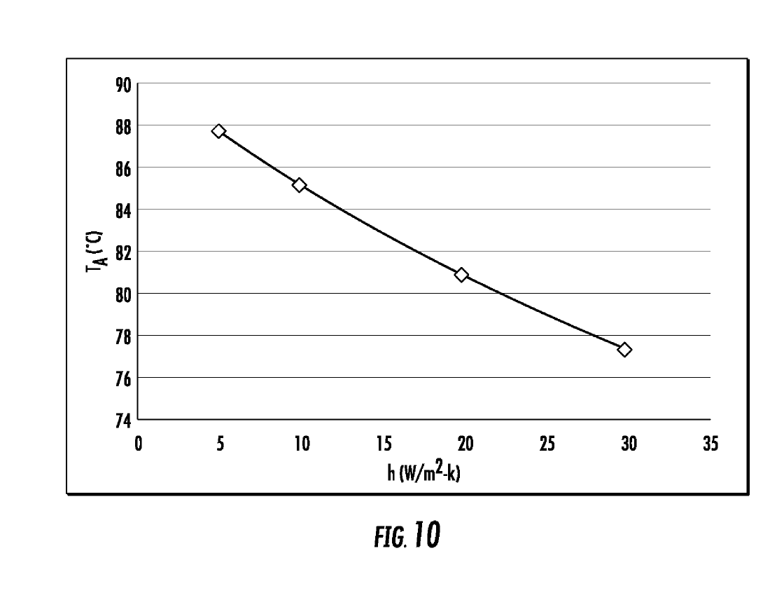

FIGS. 9 and 10 demonstrate how the material properties of the electronic package 64 shown in FIG. 6 can be integrated into the TEM 16(1) shown in FIG. 4. More specifically, FIG. 9 illustrates a relationship between the temperature estimation T_{A} of the IC block 12A shown in FIG. 4 and the thermal conductivity k of the TIM shown in FIG. 6. The thermal conductivity k of the TIM can vary during the operation of the IC 10(1) shown in FIG. 4, and thus can result in variations in the temperature estimation T_{A} calculated by implementing the TEM 16(1), as shown in FIG. 9. This relationship is integrated into the TEM 16(1) shown in FIG. 4. More specifically, the valuation of the temperature coefficients stored in the register file 46 are valuated given the variation of the thermal conductivity k. When the thermal coefficients are selected by the decoder 56 so that the thermal coefficients are provided in the temperature coefficient matrix C_{T} illustrated in the mathematical expression (2) shown in FIG. 5, the decoder 56 selects the temperature coefficients so that the variations in the thermal conductivity k of the TIM are taken into account. More specifically, the decoder 56 may select the temperature coefficients based on the IC block activity events x, past temperature estimations T, past power estimations P, and/or the like. Thus, when the temperature estimation T_{A} is calculated for different estimation cycles, the relationship between the temperature estimation T_{A} and the thermal conductivity k shown in FIG. 9 may be followed.

FIG. 10 is a graph illustrating a relationship between the temperature estimation T_{A} of the IC block 12A shown in FIG. 4 and the heat transfer coefficient h of the heat sink 74 shown in FIG. 6. Like the thermal conductivity k expressed in FIG. 9, the heat transfer coefficient h can vary during operation. Thus, similar to the thermal conductivity k, the decoder 56 can further select the temperature coefficients of the temperature coefficient matrix C_{T} based on the IC block activity events x, past temperature estimations T or past power estimations P. Thus, as the temperature estimation T_{A} is calculated during different estimation cycles, the relationship between the heat transfer coefficient h and the temperature estimation T_{A} shown in FIG. 10 can be followed.

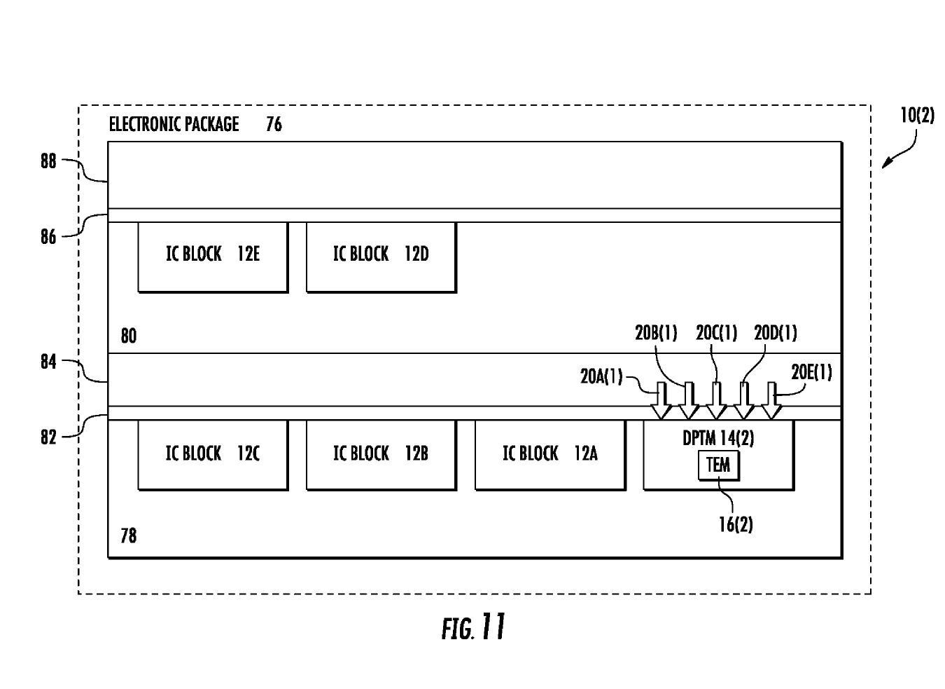

FIG. 11 illustrates an IC 10(2), which is another embodiment of the IC 10 shown in FIG. 1. The IC 10(2) includes the IC blocks 12 and a DPTM 14(2). The IC 10(2) is integrated into an electronic package 76. FIG. 11 is a cross-sectional view of the electronic package 76. More specifically, the electronic package 76 includes a stack of semiconductor dice 78, 80. In this embodiment, the IC block 12A, the IC block 12B, and the IC block 12C are formed on a first semiconductor die 78. The DPTM 14(2) is also formed on the first semiconductor die 78. However, the IC block 12D and the IC block 12E are formed on a second semiconductor die 80. The IC blocks 12 are thus formed on the stack of semiconductor dice 78, 80 such that the IC 10(2) has a three-dimensional (3-D) topology.

In this embodiment, an isolation layer 82 is provided over the first semiconductor die 78. A BEOL 84 is formed over the isolation layer 82. The second semiconductor die 80 is formed over the BEOL 84. An isolation layer 86 is formed over the second semiconductor die 80. Another BEOL 88 may be formed on the isolation layer 86. A package substrate (not shown) may be mounted on the BEOL 88 so that the IC blocks 12 and the DPTM 14(2) may receive or transmit external signals. The DPTM 14(2) is the same as the DPTM 14(1) shown in FIGS. 3 and 4, and a TEM 16(2) is the same as the TEM 16(1) shown in FIGS. 3 and 4, except that in this embodiment, one or more topological descriptions (e.g., a floorplan, an IC stack layout, and/or an IC package description) of the IC 10(2) are integrated into the TEM 16(2). The event increments 20A(1), 20B(1), 20C(1), 20D(1), and 20E(1) are received by the DPTM 14(2) through the BEOL 84. Any type of vertical connection structure, such as through-silicon vias (TSVs), may be utilized to couple the IC block 12D and the IC block 12E to the BEOL 84 in order for the BEOL 84 to receive the event increment 20D(1) and the event increment 20E(1) from the IC blocks 12D and 12E, respectively.

The IC 10 and the DTE 14 according to embodiments disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

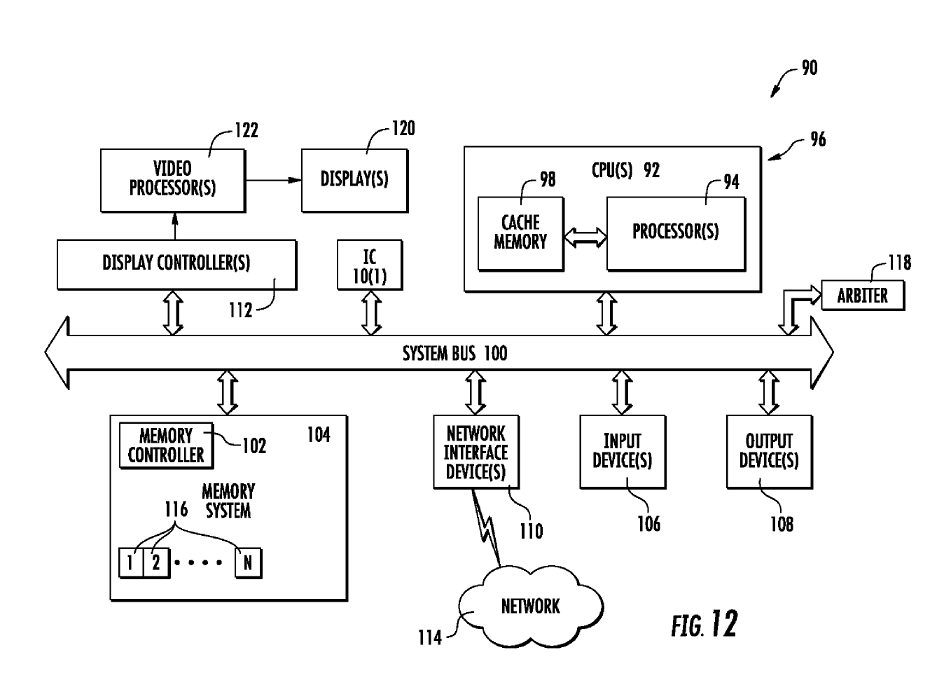

In this regard, FIG. 12 illustrates an example of a processor-based system 90 that can employ the IC 10(1) illustrated in FIG. 4 or any of the other ICs disclosed herein. In this example, the processor-based system 90 includes one or more central processing units (CPUs) 92, each including one or more processors 94. The CPU(s) 92 may be a master device 96. The CPU(s) 92 may have cache memory 98 coupled to the processor(s) 94 for rapid access to temporarily stored data. The CPU(s) 92 may be coupled to a system bus 100 and can intercouple master devices and slave devices included in the processor-based system 90. The system bus 100 may be a bus interconnect. As is well known, the CPU(s) 92 may communicate with these other devices by exchanging address, control, and data information over the system bus 100. For example, the CPU(s) 92 can communicate bus transaction requests to a memory controller 102 as an example of a slave device. Although not illustrated in FIG. 12, multiple system buses 100 could be provided, wherein each system bus 100 constitutes a different fabric.

Other master and slave devices can be connected to the system bus 100. As illustrated in FIG. 12, these devices can include a memory system 104, one or more input devices 106, one or more output devices 108, one or more network interface devices 110, the IC 10(1), and one or more display controllers 112, as examples. The input device(s) 106 can include any type of input device, including but not limited to input keys, switches, voice processors, etc. The output device(s) 108 can include any type of output device, including but not limited to audio, video, other visual indicators, etc. The network interface device(s) 110 can be any devices configured to allow exchange of data to and from a network 114. The network 114 can be any type of network, including but not limited to a wired or wireless network, a private or public network, a local area network (LAN), a wide local area network (WLAN), and the Internet. The network interface device(s) 110 can be configured to support any type of communication protocol desired. The memory system 104 can include one or more memory units 116. An arbiter 118 may be provided between the system bus 100 and master and slave devices coupled to the system bus 100, such as, for example, the memory units 116 provided in the memory system 104.

The CPU(s) 92 may also be configured to access the display controller(s) 112 over the system bus 100 to control information sent to one or more displays 120. The display controller(s) 112 may send information to the display(s) 120 to be displayed via one or more video processors 122, which process the information to be displayed into a format suitable for the display(s) 120. The display(s) 120 can include any type of display, including but not limited to a cathode ray tube (CRT), a liquid crystal display (LCD), a plasma display, etc.

The CPU(s) 92 and the display controller(s) 112 may act as master devices to make memory access requests to the arbiter 118 over the system bus 100. Different threads within the CPU(s) 92 and the display controller(s) 112 may make requests to the arbiter 118. The CPU(s) 92 and the display controller(s) 112 may provide an MID to the arbiter 118 as part of a bus transaction request.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, calculators, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A digital temperature estimator (DTE) disposed in an integrated circuit (IC), comprising:
an IC block activity file configured to store IC block activity events associated with a plurality of IC blocks disposed in an IC;
a temperature estimation model (TEM) configured to correlate the IC block activity events to temperature; and
a temperature estimation calculator configured to:
receive one or more IC block identifiers to estimate one or more temperatures of one or more IC blocks of the plurality of IC blocks identified by the one or more IC block identifiers;
implement the TEM to calculate one or more temperature estimations of the one or more IC blocks identified by the one or more IC block identifiers; and
cause the one or more temperature estimations of the one or more IC blocks identified by the one or more IC block identifiers to be stored in memory.

2. The DTE of claim 1, wherein the IC block activity events do not include power measurements, voltage measurements, and current measurements.

3. The DTE of claim 1, wherein the IC block activity file is configured to receive activity event information associated with the plurality of IC blocks in the IC in real time, wherein the IC block activity events are based on the activity event information.

4. The DTE of claim 3, wherein the IC block activity file comprises event counters and event registers and wherein:
the event registers are configured to store the IC block activity events associated with the plurality of IC blocks;
the activity event information comprises event increments; and
the event counters are configured to:
receive the event increments; and
increment at least some of the IC block activity events stored in the IC block activity file in accordance with the event increments in real time.

5. The DTE of claim 1, wherein the temperature estimation calculator is configured to implement the TEM to calculate the one or more temperature estimations of the one or more IC blocks identified by the one or more IC block identifiers by being configured to:
calculating power estimations that correspond injectively with the plurality of IC blocks based on the IC block activity events; and
calculating the one or more temperature estimations based on the power estimations that correspond injectively with the plurality of IC blocks based on the IC block activity events.

6. The DTE of claim 1, wherein the TEM is a power and temperature estimation model comprising:
a power estimation submodel configured to correlate the IC block activity events to power; and
a temperature estimation submodel configured to correlate the power to the temperature.

7. The DTE of claim 6, wherein the temperature estimation calculator is configured to implement the TEM to calculate the one or more temperature estimations of the one or more IC blocks identified by the one or more IC block identifiers by being configured to:
implement the power estimation submodel to calculate power estimations that correspond injectively with the plurality of IC blocks, wherein each of the power estimations is correlated with the IC block activity events; and
implement the temperature estimation submodel to calculate the one or more temperature estimations of the one or more IC blocks identified by the one or more IC block identifiers, wherein each of the one or more temperature estimations is correlated with the power estimations calculated with the power estimation submodel.

8. The DTE of claim 1, further comprising a controller configured to:
initiate an estimation operation for the one or more IC blocks of the plurality of IC blocks;
receive the IC block activity events from IC block activity registers associated with the plurality of IC blocks in the IC;
transmit the IC block activity events to the temperature estimation calculator;
receive the one or more temperature estimations of the one or more IC blocks in the IC from the temperature estimation calculator; and
load the one or more temperature estimations into the memory.

9. The DTE of claim 1, wherein the temperature estimation calculator is further configured to:
receive the one or more IC block identifiers to estimate the one or more temperatures of the one or more IC blocks of the plurality of IC blocks identified by the one or more IC block identifiers by receiving a set of IC block identifiers to estimate temperatures of a set of the IC blocks of the plurality of IC blocks identified by the set of IC block identifiers, wherein the set of IC block identifiers includes the one or more IC block identifiers and the temperatures include the one or more temperatures of the one or more IC blocks;
implement the TEM to calculate the one or more temperature estimations of the one or more IC blocks identified by the one or more IC block identifiers by implementing the TEM to calculate temperature estimations of the set of the IC blocks identified by the set of IC block identifiers, wherein the temperature estimations include the one or more temperature estimations; and
cause the one or more temperature estimations of the one or more IC blocks identified by the one or more IC block identifiers to be stored in the memory by causing the temperature estimations of the set of IC blocks to be stored in the memory.

10. The DTE of claim 8, wherein the controller is further configured to:
store at least one topological description describing a physical topology of the IC; and
map the one or more temperature estimations to the at least one topological description.

11. The DTE of claim 1, wherein at least one topological description describing a physical topology of the IC is integrated into the TEM such that the TEM further correlates the IC block activity events to the temperature given the at least one topological description.

12. The DTE of claim 1 integrated into a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

13. A temperature estimation method, comprising:
storing a temperature estimation model (TEM) configured to correlate integrated circuit (IC) block activity events to temperature;
obtaining the IC block activity events associated with a plurality of IC blocks disposed in an IC;
obtaining one or more IC block identifiers to estimate one or more temperatures of one or more IC blocks of the plurality of IC blocks identified by the one or more IC block identifiers;
implementing the TEM to calculate one or more temperature estimations of the one or more IC blocks identified by the one or more IC block identifiers; and
storing the one or more temperature estimations of the one or more IC blocks identified by the one or more IC block identifiers in memory.

14. The temperature estimation method of claim 13, wherein obtaining the IC block activity events associated with the plurality of IC blocks comprises receiving activity event information associated with the plurality of IC blocks in the IC in real time, wherein the IC block activity events are based on the activity event information.

15. The temperature estimation method of claim 14, wherein receiving the activity event information associated with the plurality of IC blocks in the IC in real time comprises receiving at least some of the activity event information as event increments and wherein obtaining the IC block activity events associated with the plurality of IC blocks further comprises incrementing at least some of the IC block activity events obtained previously in accordance with the event increments in real time.

16. The temperature estimation method of claim 13, wherein implementing the TEM to calculate the one or more temperature estimations of the one or more IC blocks identified by the one or more IC block identifiers comprises:
calculating power estimations that correspond injectively with the plurality of IC blocks based on the IC block activity events; and
calculating the one or more temperature estimations based on the power estimations that correspond injectively with the plurality of IC blocks based on the IC block activity events.

17. The temperature estimation method of claim 13, wherein the TEM includes a power estimation submodel configured to correlate the IC block activity events to power and a temperature estimation submodel configured to correlate the power to the temperature, and wherein implementing the TEM to calculate the one or more temperature estimations of the one or more IC blocks identified by the one or more IC block identifiers comprises:
implementing the power estimation submodel to calculate power estimations that correspond injectively with the plurality of IC blocks, wherein each of the power estimations is correlated with the IC block activity events; and
implementing the temperature estimation submodel to calculate the one or more temperature estimations of the one or more IC blocks identified by the one or more IC block identifiers, wherein each of the one or more temperature estimations is correlated with the power estimations calculated with the power estimation submodel.

18. An integrated circuit (IC), comprising:
a plurality of IC blocks;
a digital temperature estimator (DTE) having a temperature estimation model (TEM), wherein the DTE is configured to:
obtain IC block activity events associated with the plurality of IC blocks;
implement the TEM to calculate one or more temperature estimations of one or more of the plurality of IC blocks as a function of the IC block activity events.

19. The IC of claim 18, wherein the IC is integrated into an electronic package, wherein the electronic package comprises a semiconductor die and the IC is formed on the semiconductor die so as to have a two-dimensional (2-D) topology and each of the plurality of IC blocks is formed on the semiconductor die.

20. The IC of claim 18, wherein the IC is integrated into an electronic package, the electronic package comprising a stack of semiconductor dice, and wherein the IC is formed by the stack of semiconductor dice so as to have a three-dimensional (3-D) topology.
